(19) United States
(12) Patent Application Publication
(10) Pub. No.: US 2017/0142188 A1
(43) Pub. Date: May 18, 2017

(54) METHOD FOR ESTABLSHING, CONFIGURING, AND MANAGING A TRANSIENT SOCIAL GROUP

(71) Applicant: International Business Machines Corporation, Armonk, NY (US)

(72) Inventors: David Y. Chang, Austin, TX (US); Ching-Yun Chao, Austin, TX (US); Yi-Hsiu H. Wei, Austin, TX (US)

(21) Appl. No.: 14/938,950

(22) Filed: Nov. 12, 2015

(51) Int. Cl. H04L 29/08

(52) U.S. Cl. CPC H04L 67/10; G06Q 50/01

(57) ABSTRACT

A method of establishing, configuring, and managing a transient social group includes identifying, through a processor, at least one communication hub associated with the transient social group, linking to the at least one communication hub through at least one communication protocol, and developing, through the processor, a communication path through the at least one communication hub to connect a first peer of the transient social group with a second peer of the transient social group using the at least one communication protocol.

### BACKGROUND

The present invention relates to the art of social networking and, more particularly, to a method and system for establishing, configuring, and managing a transient social group.

Internet social networking allows large numbers of individuals, companies, groups and the like to communicate through various applications. Internet social networking allows those individuals, companies, groups etc. to express an interest in one another, follow updates, share news, ideas, points of view, and other information. Unfortunately, Internet communication is not available in all locations. Shopping malls, sports arenas, city streets, and other locations oftentimes either lack, or include Internet connections that are slow due to high traffic that may overwhelm connection capacity. Social groups that may form in such places are at a communication disadvantage due to slow Internet speeds and/or lack of connectivity.

### SUMMARY

According to an exemplary embodiment, a method of establishing, configuring, and managing a transient social group includes identifying, through a processor, at least one communication hub associated with the transient social group, linking to the at least one communication hub through at least one communication protocol, and developing, through the processor, a communication path through the at least one communication hub to connect a first peer of the transient social group with a second peer of the transient social group using the at least one communication protocol.

According to another aspect of an exemplary embodiment, a computer program product for establishing, configuring, and managing a transient social group comprising a computer readable storage medium having computer readable program code embodied therewith, the computer readable program code, when executed by a processor, causing the processor to: establish, through a processor, at least one communication hub associated with the transient social group, link to the at least one communication hub through at least one communication protocol, and develop, through the processor, at least one communication path through the at least one communication hub to connect a first peer of the transient social group with a second peer of the transient social group using the at least one communication protocol.

According to yet another aspect of an exemplary embodiment, a system includes a social networking device, and a system for establishing, configuring, and managing a transient social group provided in the social networking device. The system includes a processing unit (CPU) arranged operatively connected to a non-volatile memory, a communication path (CP) development and management module and a communication module. The communication path development and management module is configured and disposed to establish a communication path between a first peer of the transient social group and a second peer of the transient social group through one or more other social networking devices.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a system for establishing, configuring, and managing a transient social group, in accordance with an exemplary embodiment;

FIG. 2 depicts a flow chart illustrating a method of establishing, configuring, and managing a transient social group;

FIG. 3 depicts a multi-hub communication path, in accordance with an aspect of an exemplary embodiment

FIG. 4 depicts a multi-hub probabilistic communication path, in accordance with another aspect of an exemplary embodiment;

FIG. 5 depicts a multi-hub probabilistic communication path, in accordance with yet another aspect of an exemplary embodiment; and

FIG. 6 depicts a multi-hub probabilistic communication path, in accordance with still yet another aspect of an exemplary embodiment.

### DETAILED DESCRIPTION

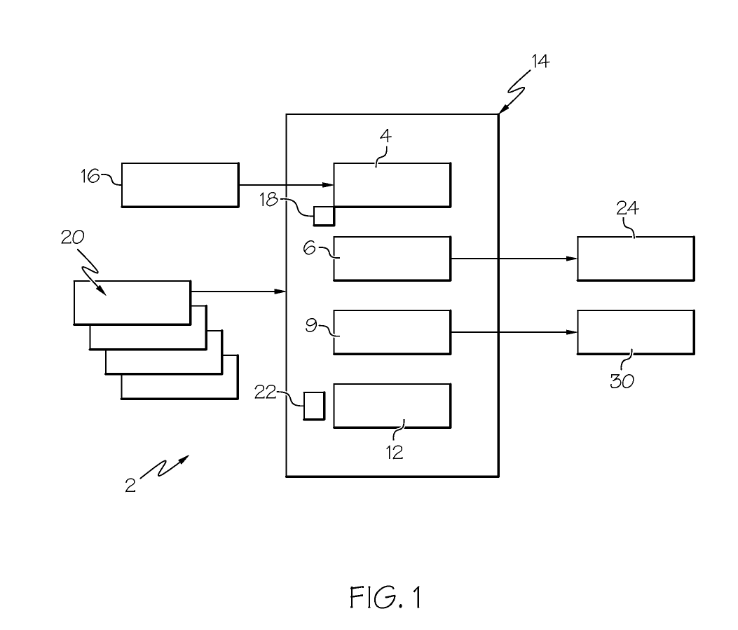

With reference now to FIG. 1, a system for establishing, configuring, and managing a transient social group is indicated generally at 2. System 2 includes a central processing unit (CPU) 4 operatively connected to a non-volatile memory 6. System 2 also includes a communication path (CP) development and management module 9 and a communication module 12. System 2 may be incorporated into a portable social networking device 14 such as a smart phone, a smart tablet, a laptop computer, and the like. Communication module 12 may employ a variety of communication protocols, such as Bluetooth® to link multiple social networking devices into a transient social group. Portable social networking device 14 may receive local inputs 16 through a local input device 18 such as a touchscreen, a keyboard, and the like, as well as remote inputs 20 through a receiver 22. Receiver 22 may be configured, for example, to receive Bluetooth® communications. Additionally, portable social networking device 14 may include a probabilistic path output 24 and a communication output 30.

The term “transient social group” should be understood to describe a group of individuals gathered at a place for a purpose and whom which to communicate with one another. For example, a transient social group may exist at a sporting event, a shopping mall, a political rally, a demonstration, or an airport. Individuals gathered at such places may wish to communicate with one another to share news updates, perspectives, and the like. The individuals may be known to one another, or part of other social networking groups having a shared interest. Further, the transient social group may develop in a location with limited wired and or wireless service such that real-time communication between group members may be hampered.

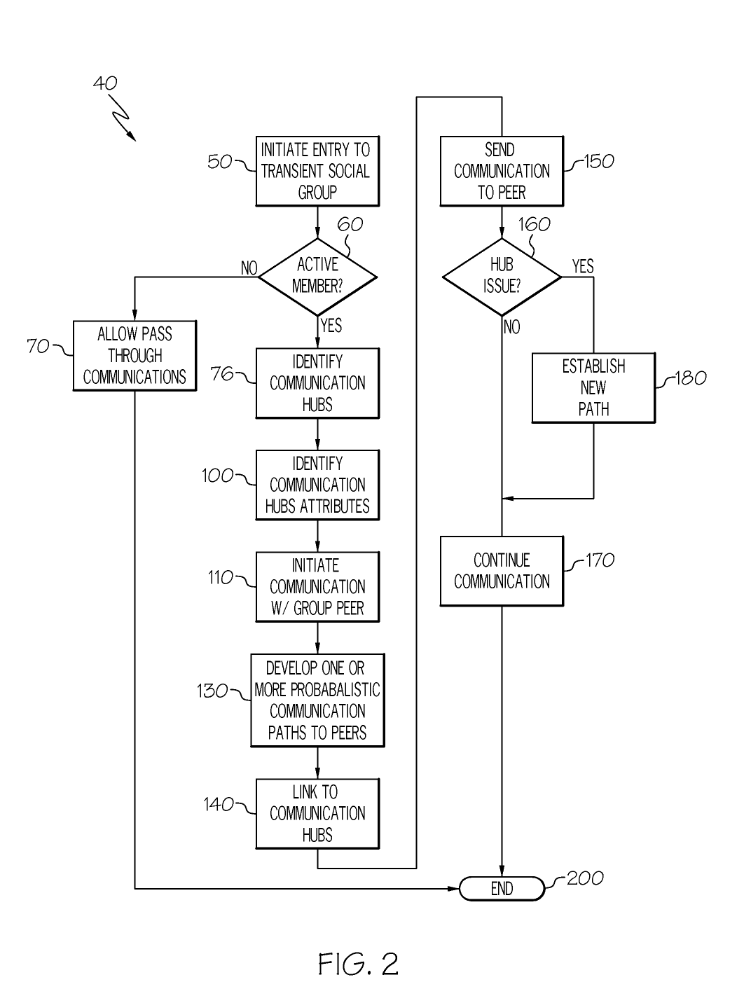

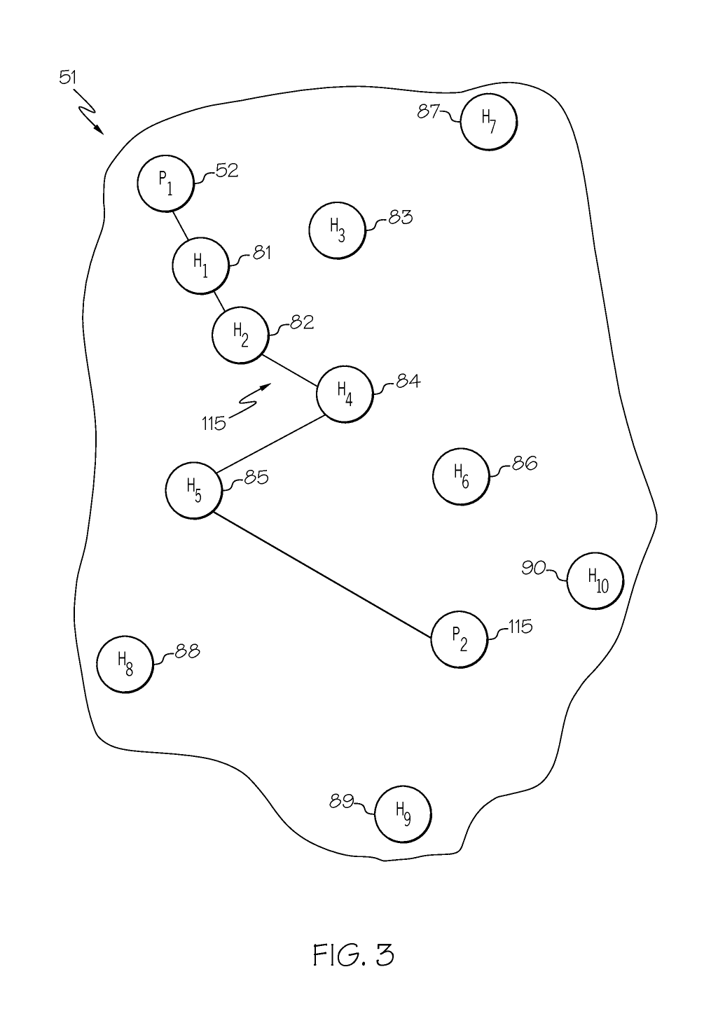

Reference will now follow to FIG. 2 in describing a method 40 of establishing, configuring, and managing a transient social group, in accordance with an exemplary embodiment. In block 50, entry into a transient social group 51 is initiated. Entry into the group 51 may be initiated through a variety of pathways. For example, a first peer 52 (FIG. 3) may have an application on portable social networking device 14 that passively monitors for transient social groups 51 and provides an option for entry. Alternatively, first peer 52 may enter an area where a transient social group 51 is expected and scan, through portable social networking device 14, for a group of interest. In block 60, a determination is made whether first peer 52 is an active member of the group, e.g., desired to communicate with one or more members of the group, or a passive member, e.g., will allow portable networking device 14 to act as a hub and allow pass-through communications, in block 70.

If first peer 52 chooses to be an active member of transient social group 51, communication hubs associates with transient social group 52 are identified in block 76. At this point, it should be understood that the term “associated” describes communication hubs such as hubs 81-90, which may represent active and/or inactive members of transient social group 51. That is, hubs 81-90 may represent social networking devices associated with other peers in the transient social group (active members), or social networking devices that are enabled to facilitate communication between members of the transient social group (inactive members). As noted above, inactive members are willing to facilitate a communication path through for example an application or the like stored on their social networking device and thereby allow pass-through communications. Active members are engaged in peer-to-peer(s) communication. In block 100 attributes of communication hubs 81-90 are identified. Attributes may include communication type, signal strength, speed, communication load, and the like. That is, one or more of communication hubs 81-90 may be facilitating communication between a large number of peers while others of communication hubs 81-90 may be facilitating communication between a smaller number of peers.

In block 110, first peer 52 initiates communication with a second peer 115. In block 130, CP development and management module 9 establishes a multi-hub communication path 1168 between first peer 52 and second peer 115. In accordance with an aspect of an exemplary embodiment, CP development and management module 9 may broadcast a communication request from first peer 52 to second peer 115. Communication hubs 81-90 sends a connect request to one another building a connection path from first peer 52 to second peer 115. A determination is made in each communication hub 81-90 whether the multi-hub communication path 116 represents a viable communication path between first peer 52 and second peer 115. Once established, the communication path is confirmed and forward communications, e.g., communications from first peer 52 to second peer 115 and return communications, e.g., from second peer 115 to first peer 110 may be initiated.

In accordance with another aspect of an exemplary embodiment, CP development and management module 9 may determine a probabilistic communication path between first peer 52 and second peer 115. For example, CP development and management module 9 employ GPS positioning data to calculate a direction and distance from first peer 52 to second peer 115. One or more of communication hubs 81-90 within communication range of first peer 52 will forward a communication based on a probability equation (PEQ.1). Thus, when following PEQ.1, multi-hub communication path 118 becomes a multi-hub probabilistic communication path 118.

(PEQ1): P(H)=(1−((d(H,T)−D+R)/2R)ⁿ; where R=a range of a typical transmission/communication; S=first peer 52, T=second peer 115, P(H) denotes a probability that one of communication hubs 81-90 will forward a message; n is the number of times one of communication hubs 81-90 has received the same message. Further D=d(S,T). Therefore, if D>R, a message from S (first peer 52) may travel through one or more of communication hubs 81-90 to reach T (second peer 115). Equation PEQ1 describes that a probability of a peer (hub H) forwarding a message from first peer 52 is larger if H is closer to second peer 115 than first peer 52; and smaller if b H is farther away to second peer 115 than first peer 52; and the probability reduces exponentially when other devices have already forward a given message. It should be understood that equation PEQ1 generally favors devices that align along the direction from first peer 52 to second peer 115 and decrease exponentially with respect to the number of times a message has been re-transmitted. It should also be understood that equation PEQ1 provides an example of one algorithm for forwarding messages. Exemplary embodiments may include alternative probabilistic formula(s) as would be understood by one of ordinary skill in the art.

Multi-hub probabilistic communication path 118 creates a communication link between first peer 52 and second peer 115 through select ones of hubs 81-90, in block 140. CP development and management module 9 evaluates communication hubs 81-90 to determine which path would provide enhanced communication. For example, where possible and/or practical, CP development and management module 9, may establish multi-hub probabilistic communication path 118 between select ones of communication hubs 81-90 which are part of other probabilistic communication paths (not shown), have faster speeds and the like. Therefore, multi-hub probabilistic communication path 118 may not represent a shortest distance between first peer 52 and second peer 115.

For example, if first peer 52 and second peer 115 are sitting on opposite sides of a stadium (not shown), the shortest path may be directly across a playing field (also not shown). Given that the playing field would be unlikely to support communication hubs, such a path may not lead to desired communication speeds. Similarly, a clock-wise path about the stadium may represent a shorter physical distance but could include a number of heavily loaded communication hubs. Therefore, PCP development and management module 9 may establish multi-hub probabilistic communication path 118 in a counter-clockwise path about the stadium. Thus, in accordance with an exemplary embodiment, CP development and management module 9 establishes multi-hub probabilistic communication path 118 designed to enhance communication speeds, accuracy, and reliability. Once multi-hub probabilistic communication path 118 is established, communication module 12 links with select ones of communication hubs 81-90, and communications are sent from first peer 52 to second peer 115 in block 150.

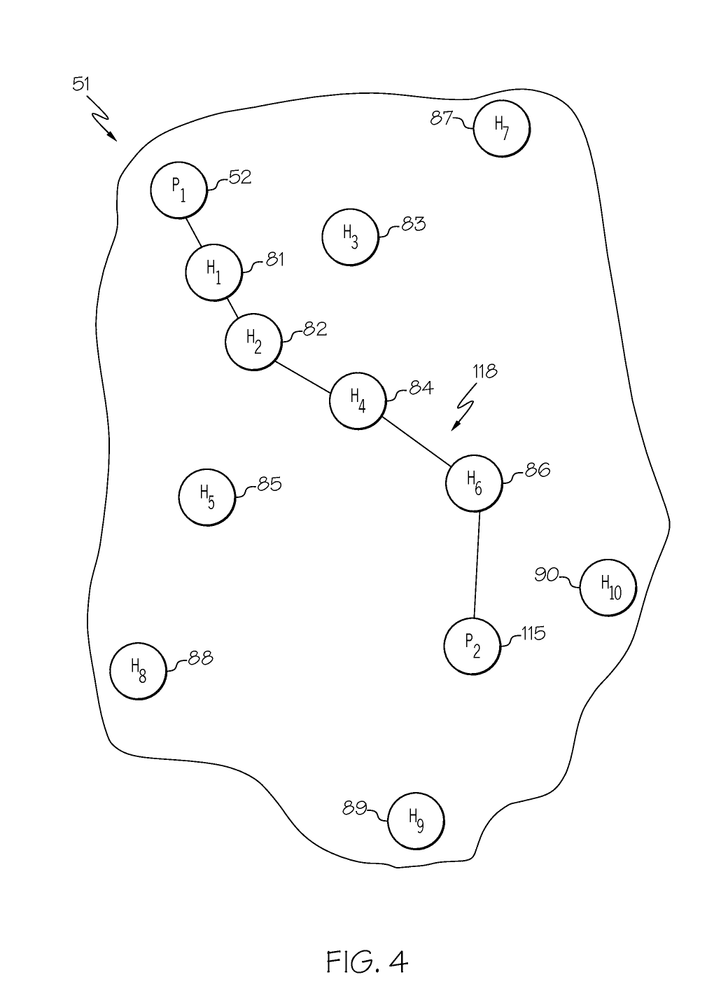

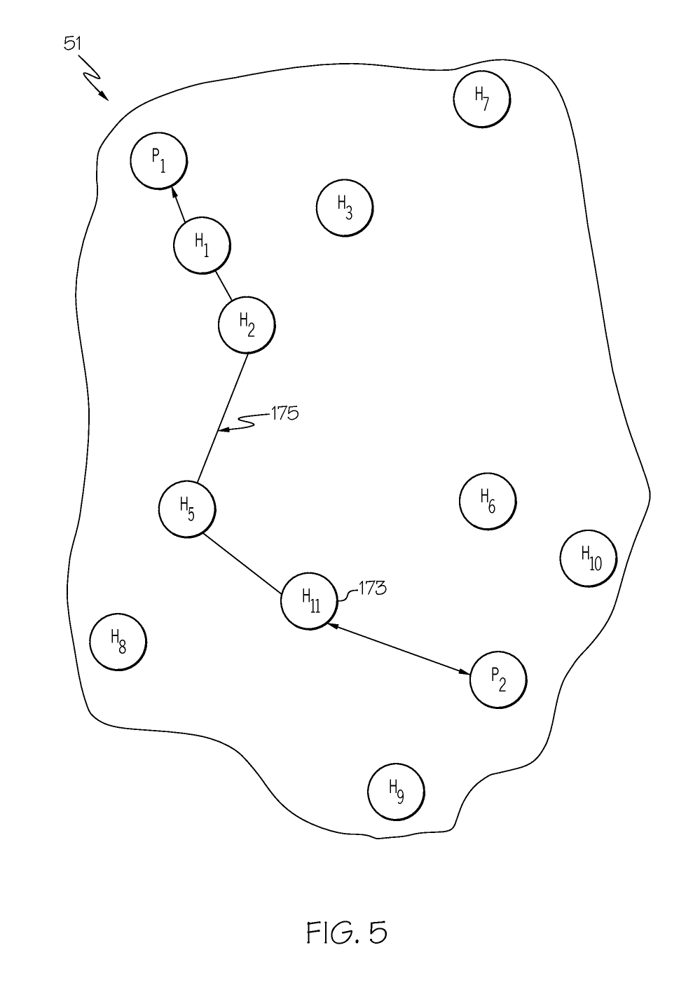

In further accordance with an exemplary embodiment, CP development and management module 9 monitors multi-hub probabilistic communication path 118 for any communication hub issues that may develop in block 160. If no issues exist, communication continues in block 170. However, communication hub 84 may become a missing communication hub, e.g. communication hub may drop out of transient social group 51 as shown in FIG. 4. That is, hub 84 may lose power, may be transported out of the area, or may otherwise completely intentionally or unintentionally disengage. As such, an open may exist in multi-hub probabilistic communication path 118. In such a case, PCP development and management module 9 reviews remaining ones of hubs 81-90, and determines whether any new hubs exist, such as communication hub 173. PCP development and management module 9 then determines a new multi-hub probabilistic communication path 175, in block 180, and communication continues in block 170. New multi-hub probabilistic communication path 175 may include new communication hub 173, as shown in FIG. 5, or may simply define a new path through communication hubs 81-90.

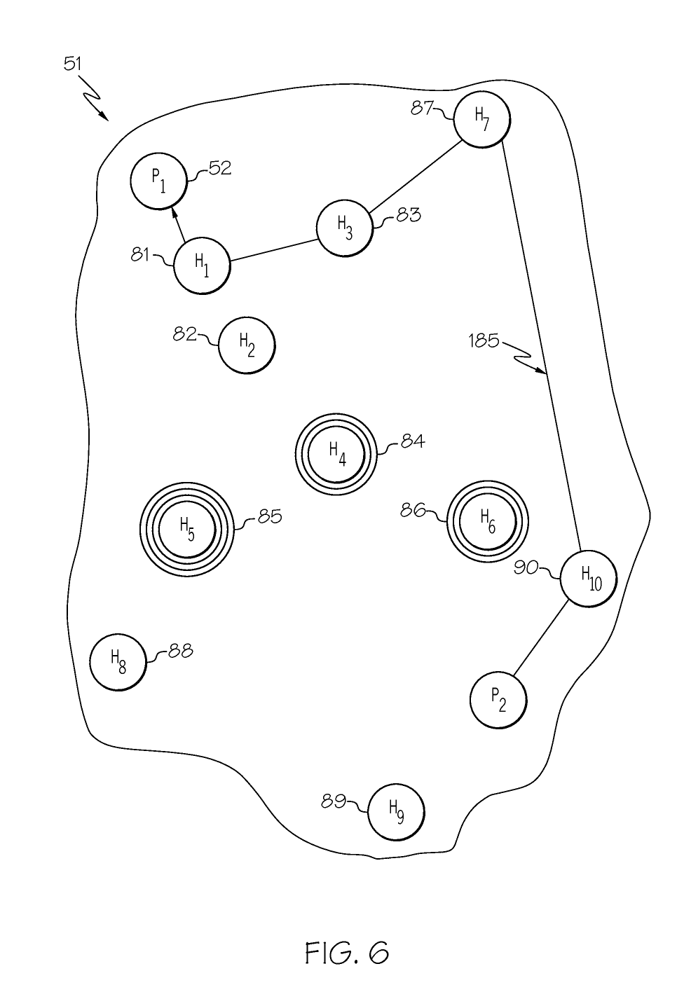

In another example, CP development and management module 9 may determine that one or more of communication hubs 81, 82, 84 and/or 86 has a heavy or high workload becoming a heavily loaded or overloaded hub(s). FIG. 6 depicts communication hubs 84, 85 and 86 as overloaded communication hubs. In such a case, in block 180, CP development and management module 9 determines a new multi-hub probabilistic communication path 185 that avoids overloaded communication hubs 84-86 in favor of low work hubs, or communication hubs having a lower workload than others of the communication hubs yet maintains a desired communication link so that communication may continue in block 170 and method 40 may end in block 200. Communications continue through existing communication hubs 81-90, new communication hub(s) 173 with the new multi-hub probabilistic communication path 175 dynamically and autonomously adapting to maintain a desired communication link between first peer 52 and second peer 115. Communication continues until, for example, transient social group 51 ceases to exist or, first peer 52 withdraws.

At this point, it should be understood that the system for establishing, configuring, and managing a transient social group in accordance with an exemplary embodiment enables a first peer to communicate with the second peer, and/or others of the transient social group through one or more dynamically configured and managed probabilistic communication paths. The CP development and management module automatically establishes, maintains and/or adopts each multi-hub probabilistic communication path to accommodate a changing communication landscape within the transient social group. Further, the CP development and management module may employ a variety of techniques, including GPS positioning of each communication hub to form the multi-hub probabilistic communication path.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of establishing, configuring, and managing a transient social group comprising:
identifying, through a processor, at least one communication hub associated with the transient social group;
linking to the at least one communication hub through at least one communication protocol; and
developing, through the processor, a communication path through the at least one communication hub to connect a first peer of the transient social group with a second peer of the transient social group using the at least one communication protocol.

2. The method of claim 1, wherein identifying at least one communication hub associated with the transient social group includes identifying multiple communication hubs associated with the transient social group.

3. The method of claim 2, wherein developing the communication path includes developing a multi-hub communication path between the first peer and the second peer through the multiple communication hubs.

4. The method of claim 3, wherein developing the multi-hub communication path includes developing, through the processor a multi-hub probabilistic communication path between the first peer and the second peer linking select ones of the multiple communication hubs.

5. The method of claim 4, wherein developing the multi-hub probabilistic communication path includes identifying one or more of the multiple communication hubs having a work load lower than others of the multiple communication hubs, defining a low work hub.

6. The method of claim 5, wherein developing the multi-hub probabilistic communication path includes establishing the multi-hub path probabilistic communication through one or more of the low work hubs.

7. The method of claim 4, further comprising: identifying, through the processor, one or more of the multiple communication hubs dropping out of the multi-hub probabilistic communication path creating a missing communication hub.

8. The method of claim 7, further comprising: establishing, through the processor, a new multi-hub probabilistic communication path connecting the two peers through remaining ones of the multiple communication hubs without the missing communication hub.

9. The method of claim 1, wherein linking the multiple communication hubs through the at least one communication protocol includes establishing a Bluetooth® connection between the multiple communication hubs.

10. The method of claim 1, further comprising: establishing, through the processor, additional communication hubs not associated with the transient social group.

11. A computer program product for establishing, configuring, and managing a transient social group comprising a computer readable storage medium having computer readable program code embodied therewith, the computer readable program code, when executed by a processor, causing the processor to:
establish, through a processor, at least one communication hub associated with the transient social group;
link to the at least one communication hub through at least one communication protocol; and
develop, through the processor, at least one communication path through the at least one communication hub to connect a first peer of the transient social group with a second peer of the transient social group using the at least one communication protocol.

12. The computer program product according to claim 11, wherein the computer readable program code, when executed by a processor, causes the processor to: identify multiple communication hubs associated with the transient social group.

13. The computer program product according to claim 12, wherein the computer readable program code, when executed by a processor, causes the processor to: develop a multi-hub communication path between the first peer and the second peer through the multiple communication hubs.

14. The computer program product of claim 13, wherein the computer readable program code, when executed by a processor, causes the processor to: develop a multi-hub probabilistic communication path between the first peer and the second peer.

15. The computer program product of claim 14, wherein the computer readable program code, when executed by a processor, causes the processor to: identify multiple communication hubs having a work load lower than others of the multiple communication hubs, defining a low work hub.

16. The computer program product of claim 15, wherein the computer readable program code, when executed by a processor, causes the processor to: establish the multi-hub probabilistic communication path through one or more of the low work hubs.

17. The computer program product of claim 14, wherein the computer readable program code, when executed by a processor, causes the processor to: identify, through the processor, one or more of the multiple communication hubs dropping out of the multi-hub probabilistic communication path creating a missing communication hub.

18. The computer program product of claim 17, wherein the computer readable program code, when executed by a processor, causes the processor to: establish, through the processor, a new multi-hub probabilistic communication path connecting the first peer and the second peer through remaining ones of the multiple communication hubs without the missing communication hub.

19. A system comprising:
a social networking device; and
a system for establishing, configuring, and managing a transient social group provided in the social networking device, the system including a processing unit (CPU) arranged operatively connected to a non-volatile memory, a communication path (CP) development and management module and a communication module, wherein the communication path development and management module is configured and disposed to establish a communication path between a first peer of the transient social group and a second peer of the transient social group through one or more other social networking devices.

20. The system according to claim 19, wherein the communication path development and management module is configured and disposed to establish a multi-hub probabilistic communication path between the first peer of the transient social group and the second peer of the transient social group.
